(19) United States
(12) Patent Application Publication
(10) Pub. No.: US 2026/0290722 A1
(43) Pub. Date: Sep. 24, 2026

(54) INPUT DEVICE

(71) Applicant: Yamaha Corporation, Hamamatsu (JP)

(72) Inventor: Junji ENDO, Hamamatsu (JP)

(21) Appl. No.: 19/570,395

(22) Filed: Mar. 18, 2026

(30) Foreign Application Priority Data
Mar. 19, 2025 (JP) 2025-045677

(51) Int. Cl. H01H 13/7065; G06F 3/02; H01H 13/04; H01H 13/10; H01H 13/14; H01H 13/83

(52) U.S. Cl. CPC H01H 13/7065; G06F 3/0219; H01H 13/04; H01H 13/10; H01H 13/14; H01H 13/83

(57) ABSTRACT

An input device includes a plurality of operation parts arranged in a specific direction, a support member including openings that correspond to the operation parts, respectively, a display disposed on a rear side of the operation parts and configured to display an image, and a detector. Each operation part includes a light-transmitting part that includes an operation surface exposed from each opening, a fixed portion disposed on a fixed end of the light-transmitting part in the specific direction and fixed between the support member and the display, and a movable portion disposed at a movable end of the light-transmitting part, which is opposite to the fixed end. The movable portion is displaceable by a pressing operation on the operation surface with the fixed portion serving as a fulcrum. The detector is located between the display and the movable portion and configured to detect displacement of the movable portion.

### CROSS-REFERENCE TO RELATED APPLICATIONS

This application claims priority to Japanese Patent Application No. 2025-045677, filed on Mar. 19, 2025. The entire disclosure of Japanese Patent Application No. 2025-045677 is hereby incorporated herein by reference.

### BACKGROUND

### Technical Field

This disclosure generally relates to an input device.

### Background Information

An input device with which an image displayed on a display unit inside the input device can be seen by a user through an operation surface of a light-transmitting part of an operation part has been proposed in the prior art. For example, U.S. Pat. No. 9,818,557 discloses a structure in which a key body, a key frame, an elastic support part, a detection module, and a display are stacked from top to bottom in that order, and it is possible to see an image displayed on the display through the light-transmitting key body.

### SUMMARY

In U.S. Pat. No. 9,818,557, there is the problem that the image is difficult to see because the entire operation part shifts in the direction of the pressing operation. In addition, since the center of the operation part coincides with the center of the image, there is the problem that when the operation part is used in a tilted state, a portion of the image is cut off as viewed from the user. In consideration of such circumstances, an object of one aspect of the present disclosure is to improve the visibility of an image.

In order to solve the problem described above, an input device according to one aspect of this disclosure includes a plurality of operation parts arranged in a specific direction, a support member including a plurality of openings that correspond to each of the plurality of operation parts, a display disposed on a rear side of the plurality of operation parts, the display being configured to display an image, and a detector located between the plurality of operation parts and the display. Each of the plurality of operation parts includes a light-transmitting part that includes an operation surface exposed from each of the plurality of openings corresponding to the plurality of operation parts, respectively, the light-transmitting part being configured to transmit light emitted by the display, a fixed portion disposed at a fixed end of the light-transmitting part, the fixed portion being fixed between the support member and the display, and a movable portion at a movable end of the light-transmitting part, the movable end being opposite to the fixed end, the movable portion being displaceable by a pressing operation on the operation surface with the fixed portion serving as a fulcrum. The detection unit is located between the display and the movable portion of each of the plurality of operation parts, the detector being configured to detect displacement of the movable portion of each of the plurality of operation parts.

### BRIEF DESCRIPTION OF THE DRAWINGS

FIG. 1 is a perspective view showing a configuration of an input device according to the first embodiment.

FIG. 2 is a cross-sectional diagram taken along a line II-II in FIG. 1.

FIG. 3 is an exploded perspective view of the input device according to the first embodiment.

FIG. 4 is a perspective view showing a configuration of a support member.

FIG. 5 is a perspective view showing a configuration of a keypad.

FIG. 6 is a schematic diagram of a pressing operation on an operation part by a user.

FIG. 7 is an enlarged view of an elastic part in FIG. 2.

FIG. 8 is a cross-section diagram taken along a line VIII-VIII in FIG. 1.

FIG. 9 is a perspective view showing a configuration of a membrane switch.

FIG. 10 is a cross-section diagram taken along a line X-X in FIG. 9.

FIG. 11 is a perspective view showing a configuration of a display unit.

FIG. 12 is a perspective view showing a configuration of a plate-shaped member.

FIG. 13 is a schematic diagram showing a state in which an image is displayed on the input device of the first embodiment.

FIG. 14 is a perspective view showing a configuration of an input device according to a second embodiment.

FIG. 15 is a schematic diagram of the input device according to the second embodiment as observed from a line of sight along the X axis.

### DETAILED DESCRIPTION OF THE EMBODIMENTS

An embodiment of the present disclosure will be described with reference to the drawings. It should be noted that, in each of the drawings, the dimensions and scale of each element may differ from the actual product. In addition, the embodiments described below are exemplary embodiments that may be envisioned when implementing the present disclosure. Accordingly, the scope of the present disclosure is not limited to the embodiment illustrated below.

### A: First Embodiment

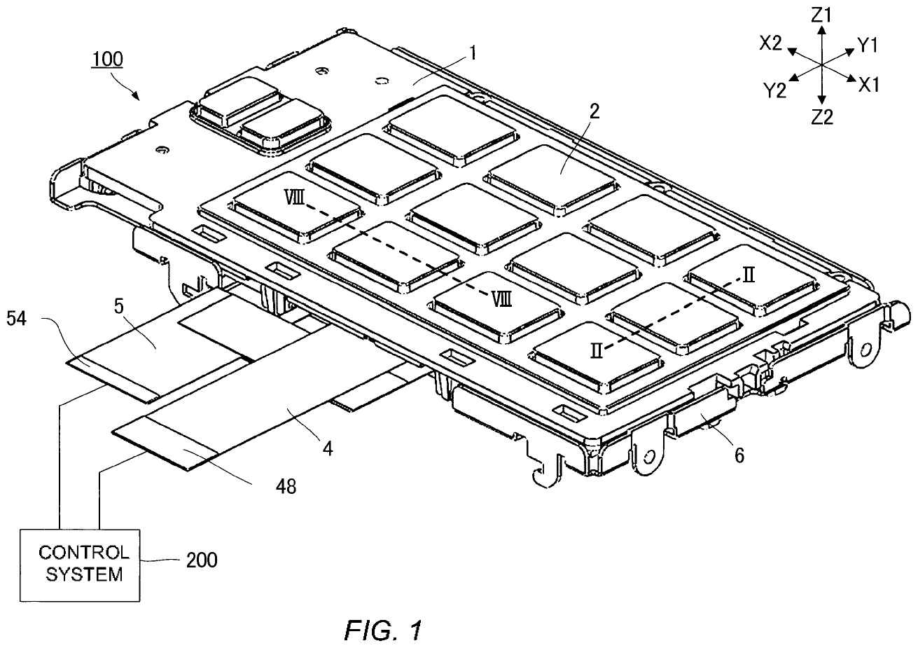

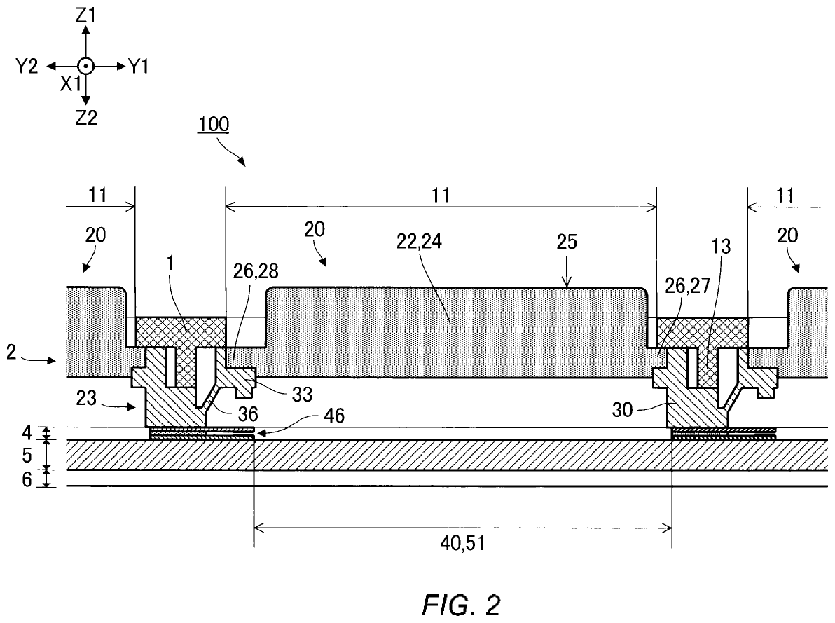

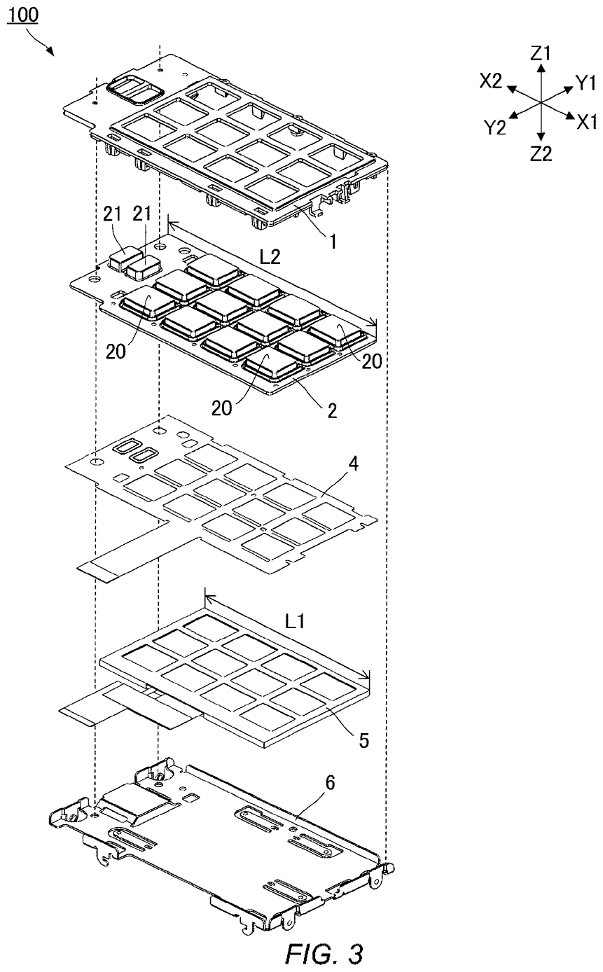

FIG. 1 is a perspective view showing a configuration of an input device 100 according to the first embodiment. FIG. 2 is a cross-sectional diagram taken along a line II-II in FIG. 1. FIG. 3 is an exploded perspective view of the input device 100 according to the first embodiment. As shown in FIGS. 1, 2, and 3, the input device 100 of the first embodiment is used as an operation device that detects a pressing operation by a user. A control system 200 is connected to the input device 100. The control system 200 is a computer system for controlling the operation of the input device 100.

The input device 100 includes a support member 1, a keypad 2, a membrane switch 4, a display unit (display) 5, and a plate-shaped member 6. The support member 1 and the plate-shaped member 6 are rectangular structures joined together by a fastener (not shown), such as a bolt, thereby constituting a hollow case. Specifically, the case in the first embodiment accommodates the keypad 2, the membrane switch 4, and the display unit 5 in the space between the support member 1 and the plate-shaped member 6.

In the following description, a Z axis is assumed extending in a direction from the support member 1 to the plate-shaped member 6. One direction along the Z axis is defined as the Z1 direction, and the direction opposite to the Z1 direction is defined as the Z2 direction. The direction from the plate-shaped member 6 toward the support member 1 is the Z1 direction. That is, the support member 1 is located in the Z1 direction of the plate-shaped member 6. In addition, X and Y axes are assumed, which are orthogonal to each other in a plane perpendicular to the Z axis. One direction along the X axis is defined as the X1 direction, and the direction opposite to the X1 direction is defined as the X2 direction. Similarly, one direction along the Y axis is defined as the Y1 direction, and the direction opposite to the Y1 direction is defined as the Y2 direction. In addition, observing a given object from a line of sight along the Z axis is referred to as “in plan view”. The Y1 direction is one example of the “specific direction.”

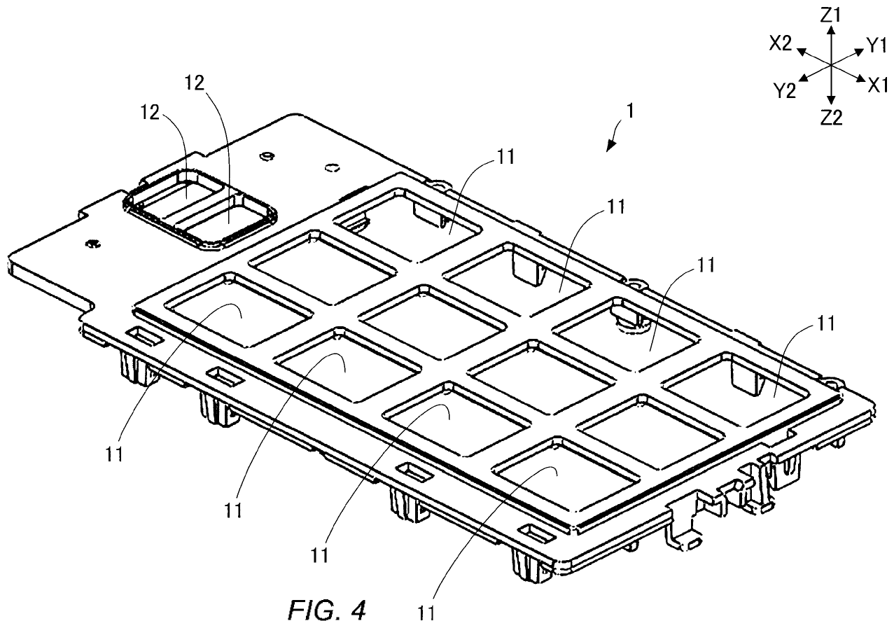

FIG. 4 is a perspective view showing a configuration of the support member 1. As illustrated in FIG. 4, the support member 1 is a rectangular structure that is elongated in the X-axis direction in plan view. The support member 1 is made of a resin material. For example, a resin material such as ABS (acrylonitrile butadiene styrene) resin can be used as the material of the support member 1. However, the material of the support member 1 is not limited to resin materials. For example, the support member 1 can be made of a metal material.

The support member 1 includes a plurality of first openings 11 and a plurality of second openings 12. The plurality of second openings 12 are located in the support member 1 further in the X2 direction than the plurality of first openings 11 in plan view. The plurality of first openings 11 is one example of the “plurality of openings.”

The plurality of first openings 11 are arranged in a matrix in the X-axis direction and the Y-axis direction. Specifically, three of the first openings 11 are arranged in the Y-axis direction. In addition, four of the first openings 11 are arranged in the X-axis direction. That is, a total of 12 of the first openings 11 are formed in the support member 1. Each of the plurality of first openings 11 has a rectangular shape that is elongated in the X-axis direction. The number, arrangement, and shape of the plurality of first openings 11 can be changed as appropriate in accordance with the dimensions, etc., of the support member 1.

The plurality of second openings 12 are arranged so as to be adjacent to each other in the X-axis direction. Specifically, two of the second openings 12 are arranged in the X-axis direction. Each of the plurality of second openings 12 has a rectangular shape that is elongated in the Y-axis direction. The number, arrangement, and shape of the plurality of second openings 12 can be changed as appropriate in accordance with the dimensions, etc., of the support member 1.

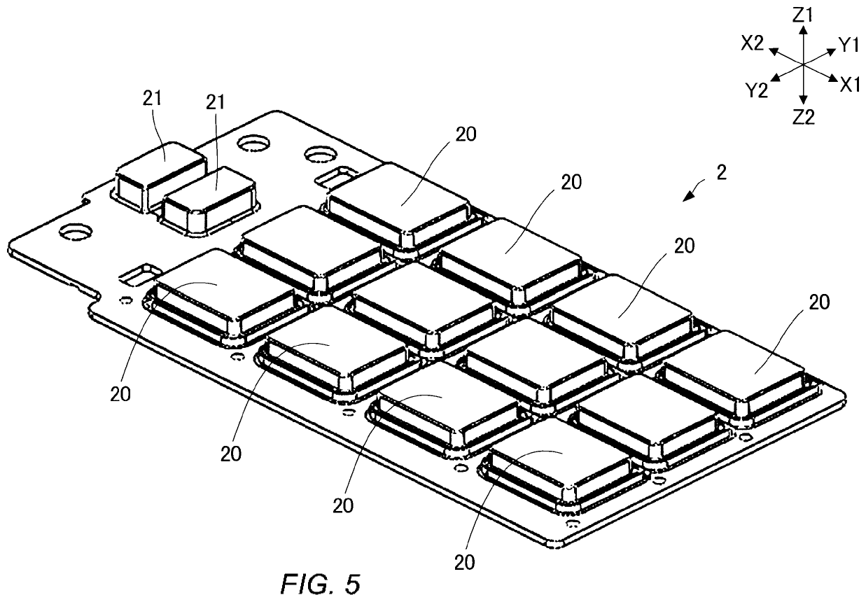

FIG. 5 is a perspective view showing a configuration of the keypad 2. As illustrated in FIG. 5, the keypad 2 is a rectangular structure that is elongated in the X-axis direction. The keypad 2 includes a plurality of operation parts 20 and a plurality of switches 21. The plurality of operation parts 20 and the plurality of switches 21 are members that are pressed by a user of the input device 100. The plurality of switches 21 are located in the support member 1 further in the X2 direction than the plurality of operation parts 20 in plan view.

The plurality of operation parts 20 respectively correspond to each of the plurality of first openings 11 provided in the support member 1. That is, the plurality of operation parts 20 are arranged in a matrix in the X-axis direction and the Y-axis direction, in the same manner as the plurality of first openings 11. Specifically, three of the operation parts 20 are arranged in the Y-axis direction. In addition, four of the operation parts 20 are arranged in the X-axis direction. That is, a total of 12 of the operation parts 20 are formed in the keypad 2. As illustrated in FIG. 2, each of the plurality of operation parts 20 includes a light-transmitting part 22 and an elastic part 23.

The light-transmitting part 22 is a structure made of a transparent resin material. For example, resin material such as polycarbonate (PC) can be used as the material of the light-transmitting part 22. The light-transmitting part 22 is a member having light-transmitting properties. The light-transmitting part 22 includes a base portion 24 that is a rectangular parallelepiped that is elongated in the X-axis direction. The surface of the base portion 24 facing the Z1 direction is an operation surface 25 on which the user of the input device 100 carries out a pressing operation. The operation surface 25 of each operation part 20 is exposed toward the Z1 direction from, among the plurality of first openings 11 of the support member 1, the first opening 11 corresponding to each operation part 20. The operation surface 25 protrudes from the upper surface of the support member 1 in the Z1 direction. That is, in the Z-axis direction, the operation surface 25 is located further in the Z1 direction than the upper surface of the support member 1.

The light-transmitting part 22 further has a flange portion 26. The flange portion 26 is a portion that protrudes from the side surface of the base portion 24 in the circumferential direction over the entire circumference. The portion of the flange portion 26 located in the Y1 direction is a fixed end 27. The fixed end 27 serves as a fulcrum for the light-transmitting part 22 in a case where the user presses the operation part 20.

The portion of the flange portion 26 located in the Y2 direction is a first movable end 28. The first movable end 28 is a portion of the light-transmitting part 22 that is displaced, when the user presses the operation part 20 (in response to the user pressing the operation part 20). The fixed end 27 and the first movable end 28 are located on opposite sides of the flange portion 26 from each other in the Y-axis direction. The first movable end 28 is one example of the “movable end.”

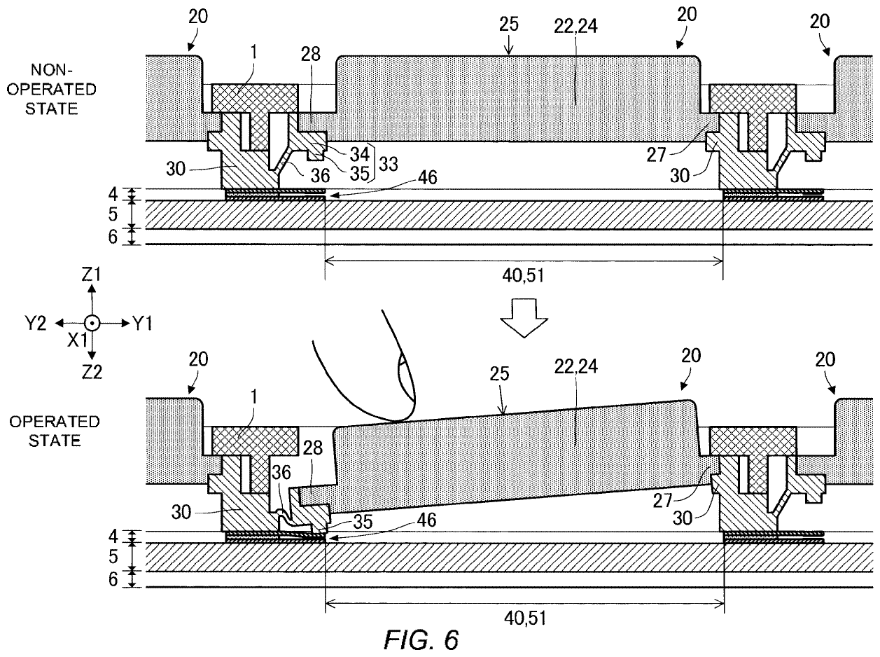

FIG. 6 is a schematic diagram of a pressing operation on the operation part 20 by a user. As illustrated in FIG. 6, when the user presses the operation surface 25 in the Z2 direction (in response to the user pressing the operation surface 25 in the Z2 direction), the light-transmitting part 22 rotates with the fixed end 27 serving as a fulcrum. Specifically, the first movable end 28 is displaced toward the Z2 direction.

As illustrated in FIG. 2, the elastic part 23 is integrally formed over the entire circumference of the side surface and the lower surface of the flange portion 26 of the light-transmitting part 22. The light-transmitting part 22 and the elastic part 23 are, for example, integrally formed by two-color molding. However, the light-transmitting part 22 and the elastic part 23 can be separately produced and joined to each other. The elastic part 23 is an elastically deformable structure. The elastic part 23 is made of a rubber material. For example, a rubber material such as silicone rubber can be used as the material of the elastic part 23. The elastic part 23 includes a first fixed portion 30, a first movable portion 33, and a connecting portion 36.

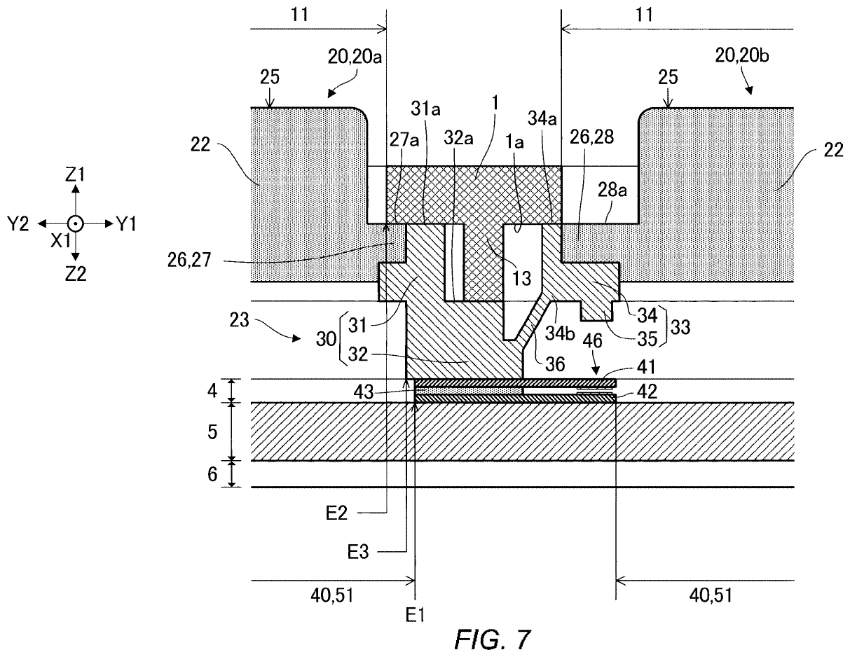

FIG. 7 is an enlarged view of the elastic part 23 in FIG. 2. As illustrated in FIG. 7, the first fixed portion 30 is placed at the fixed end 27 of the light-transmitting part 22. The first fixed portion 30 extends across the entire width (that is, in the X-axis direction) of the fixed end 27 of the light-transmitting part 22. The first fixed portion 30 supports the fixed end 27 of the flange portion 26.

Specifically, the first fixed portion 30 includes a first support portion 31 and a second support portion 32. The first support portion 31 is a portion that is integrally formed with the side surface and the lower surface of the fixed end 27. That is, the first support portion 31 is formed so as to cover the side surface and the lower surface of the fixed end 27. An upper surface 31a of the first support portion 31 and an upper surface 27a of the fixed end 27 are located in the same plane. The upper surface 31a of the first support portion 31 is in contact with a rear surface 1a of the support member 1. In addition, the lower surface of the first support portion 31 is in contact with the upper surface of the membrane switch 4. For a given element of the input device 100, the “rear surface” is the surface of the given element facing the direction opposite to the direction in which the operation surface 25 faces. That is, the rear surface in the first embodiment is a surface facing the Z2 direction. The rear surface can also be expressed as the lower surface.

The fixed end 27 of the flange portion 26 is located between the support member 1 and the first support portion 31. The fixed end 27 overlaps with the support member 1 in plan view. The upper surface 27a of the fixed end 27 is in contact with the rear surface 1a of the support member 1. Accordingly, compared to a structure in which the fixed end 27 does not contact the support member 1, the fixed end 27 of the light-transmitting part 22 can be more firmly fixed by the support member 1 and the first fixed portion 30.

A protrusion 13 is formed on the rear surface 1a of the support member 1. The input device 100 further includes the protrusion 13. The protrusion 13 is a portion that protrudes from the rear surface 1a of the support member 1 toward the Z2 direction. The protrusion 13 is located on the rear surface 1a of the support member 1 between the openings 11 that are adjacent to each other in the Y-axis direction. Specifically, the protrusion 13 extends in the X-axis direction over the entire area in which the plurality of operation parts 20 are provided on the rear surface 1a of the support member 1.

The second support portion 32 is a portion that protrudes in the Y1 direction from a side surface of the first support portion 31 facing the Y1 direction. The protrusion 13 is in contact with an upper surface 32a of the second support portion 32. The second support portion 32 is pressed by the protrusion 13 in the Z2 direction. That is, the second support portion 32 is fixed between the support member 1 and the display unit 5. Accordingly, compared to a configuration in which the support member 1 does not include the protrusion 13, the first fixed portion 30 can be more firmly fixed.

The first movable portion 33 is installed at the first movable end 28 of the light-transmitting part 22. The first movable portion 33 extends across the entire width (that is, the X-axis direction) of the first movable end 28. The first movable portion 33 supports the first movable end 28 of the flange portion 26 so as to be displaceable.

The first movable portion 33 includes a third support portion 34 and a protrusion 35. The third support portion 34 is integrally formed with the side surface and the lower surface of the first movable end 28. An upper surface 34a of the third support portion 34 is located in the same plane as an upper surface 28a of the first movable end 28. The first movable end 28 is located inside the first opening 11 of the support member 1 in plan view, and does not overlap with the support member 1 in plan view. The upper surface 34a of the third support portion 34 is in contact with the rear surface 1a of the support member 1 in a state in which the operation surface 25 is not being pressed (hereinafter referred to as “non-operated state”). As a result of the first movable portion 33 coming in contact with the rear surface 1a of the support member 1, it is possible to stabilize the position of the first movable portion 33 in the non-operated state. The first movable portion 33 is one example of the “movable portion.”

The protrusion 35 is a projection that protrudes from the rear surface of the third support portion 34 in the Z2 direction. The cross-sectional shape of the protrusion 35 is quadrangular. As illustrated in FIG. 6, the first movable portion 33 of the operation part 20 that is pressed is displaced in the Z2 direction, with the first fixed portion 30 of the operation part 20 serving as a fulcrum. In a state in which the operation surface 25 is sufficiently pressed (hereinafter referred to as “operated state”), the protrusion 35 of the first movable portion 33 presses the membrane switch 4 in the Z2 direction.

For the sake of convenience, FIG. 7 shows one of the operation parts 20a from among the plurality of operation parts 20, and another operation part 20b adjacent to the operation part 20a in the Y1 direction. As illustrated in FIG. 7, the connecting portion 36 is a thin plate-shaped portion that connects the first fixed portion 30 of the operation part 20a and the first movable portion 33 of the operation part 20b. The connecting portion 36 is a flat plate-shaped portion that is inclined relative to the Z-axis direction. Specifically, the connecting portion 36 connects a side surface facing the Y1 direction of the second fixed portion 32 in the first fixed portion 30 of the operation part 20a, and a corner portion 34b of the third support portion 34 in the first movable portion 33 of the operation part 20b. That is, the first fixed portion 30 of the operation part 20a and the first movable portion 33 of the operation part 20b are connected by the connecting portion 36.

According to the configuration described above, compared to a form in which the first fixed portion 30 of the operation part 20a and the first movable portion 33 of the operation part 20b are configured as separate bodies, it is easier to fix the relative positions of the first fixed portion 30 of the operation part 20a and the first movable portion 33 of the operation part 20b. Accordingly, it is easy to install the first fixed portion 30 of the operation part 20a and the first movable portion 33 of the operation part 20b while maintaining the target positional relationship between the first fixed portion 30 and the first movable portion 33. The operation part 20a is one example of the “first operation part,” and the operation part 20b that is adjacent to the operation part 20a in the Y1 direction in one example of the “second operation part.”

The connecting portion 36 is more susceptible to elastic deformation than the first fixed portion 30 or the first movable portion 33. As illustrated in FIG. 6, the connecting portion 36 of the operation part 20 that has been pressed is elastically deformed, using, as a fulcrum, the first fixed portion 30 of the adjacent operation part 20 that is adjacent in the Y2 direction to the operation part 20 which has been pressed. According to the aspect described above, for example, compared to a form in which the first movable portion 33 is directly connected to the first fixed portion 30, it is easier to secure a range in which the first movable portion 33 can be displaced with respect to the first fixed portion 30.

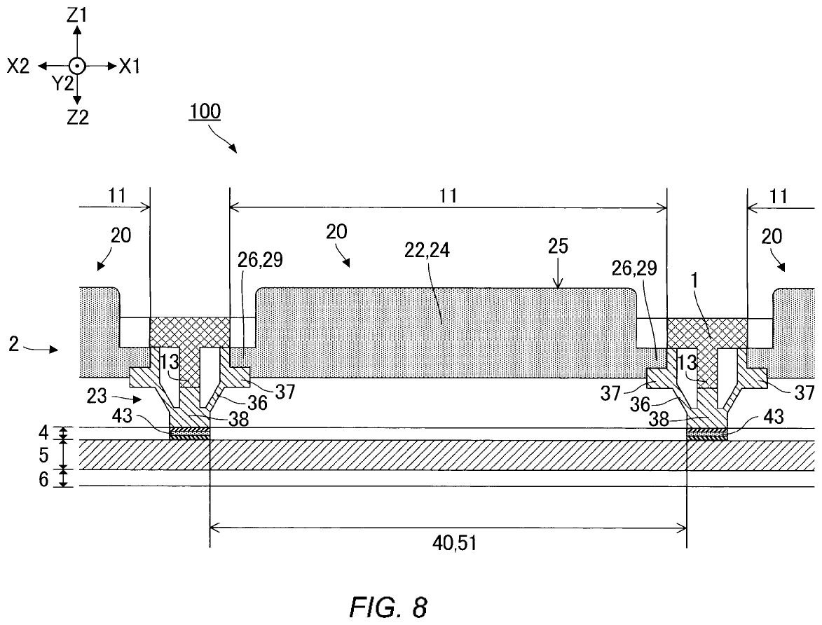

FIG. 8 is a cross-section diagram taken along a line VIII-VIII in FIG. 1. That is, a cross section along the X-Z plane is shown in FIG. 8. As illustrated in FIG. 8, the portions of the flange portion 26 located in the X1 direction and in the X2 direction are second movable ends 29. Each of the second movable end 29 is a portion of the light-transmitting part 22 that is displaced when the user presses the operation part 20 (in response to the user pressing the operation part 20).

The elastic part 23 further includes a second movable portion 37 and a second fixed portion 38. The second movable portion 37 is a portion of the elastic part 23 that is integrally formed with the second movable end 29. The second movable portion 37 has the same shape as the third support portion 34 of the above-mentioned first movable portion 33. That is, the second movable portion 37 has the same shape as the first movable portion 33, but with the protrusion 35 omitted. The second movable portion 37 extends across the entire width (that is, in the Y-axis direction) of the second movable end 29 of the light-transmitting part 22.

The second fixed portion 38 is a portion of the elastic part 23 located between the second movable portions 37 that are adjacent to each other in the X-axis direction. The second fixed portion 38 is pressed in the Z2 direction by the protrusion 13 of the support member 1. The second movable portion 37 and the second fixed portion 38 are connected by the connecting portion 36.

As illustrated in FIG. 5, the plurality of switches 21 are arranged so as to be adjacent to each other in the X-axis direction. Specifically, two of the switches 21 are arranged in the X-axis direction. The plurality of switches 21 respectively correspond to each of the plurality of second openings 12 provided in the support member 1.

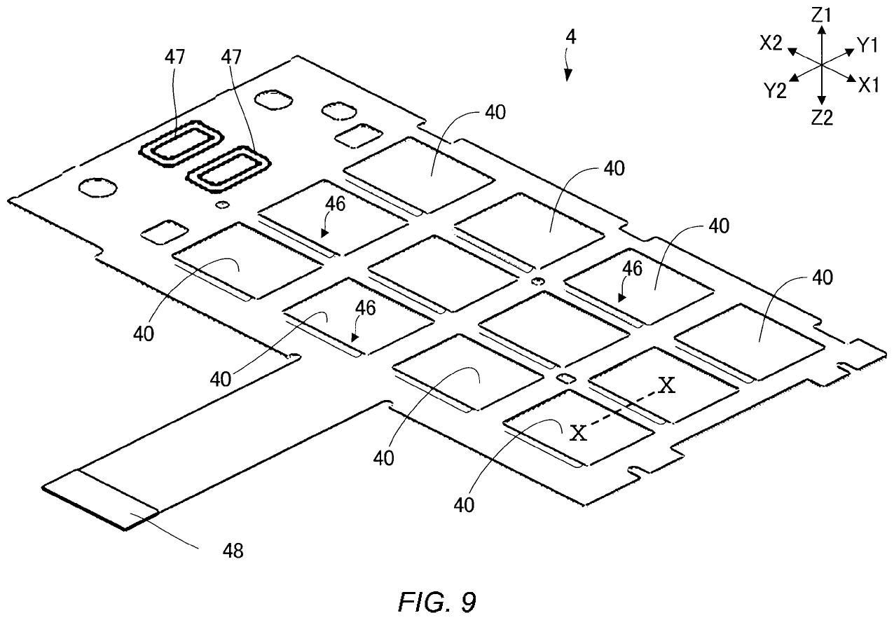

FIG. 9 is a perspective view showing a configuration of the membrane switch 4. As illustrated in FIG. 9, the membrane switch 4 is a flat plate-shaped switch. The membrane switch 4 is used as a detection unit (detector) that detects displacement of the first movable portion 33. As described above, since the flat plate-shaped membrane switch 4 is used for the detection of displacement of the first movable portion 33, compared, for example, to a form in which a mechanical switch that is displaced in conjunction with the first movable portion 33 is used as the detection unit, the thickness of the input device 100 can be reduced.

A plurality of windows 40 are formed in the membrane switch 4. The plurality of windows 40 are open respectively corresponding to the plurality of operation parts 20. In addition, a terminal 48 for external connection is provided to the membrane switch 4. The terminal 48 is connected to the control system 200 shown in FIG. 1. The membrane switch 4 supplies a signal representing the displacement of the first movable portion 33 to the control system 200 via the terminal 48.

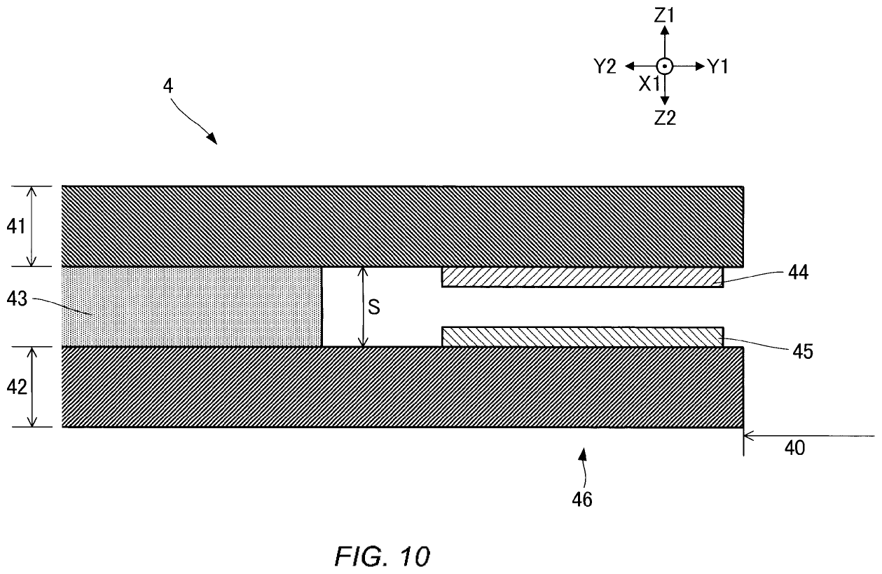

FIG. 10 is a cross-section diagram taken along a line X-X in FIG. 9. That is, a cross section along the Y-Z plane is shown in FIG. 10. As illustrated in FIG. 10, the membrane switch 4 includes a first layer 41, a second layer 42, a spacer 43, a first electrode 44, and a second electrode 45.

The first layer 41 and the second layer 42 are flexible layers. More specifically, the first layer 41 and the second layer 42 are film-shaped substrates. The material of the first layer 41 and the second layer 42 is a resin material with insulating property. A resin material such as polyethylene terephthalate (PET) can be used as the material of the first layer 41 and the second layer 42. However, the material of the first layer 41 and the second layer 42 is not limited to the example described above. As illustrated in FIG. 7, the first layer 41 and the second layer 42 are continuous in plan view across the first fixed portion 30 of the operation part 20a and the first movable portion 33 of the operation part 20b.

As illustrated in FIG. 10, the spacer 43 is a film-shaped insulating member that comes in contact with the first layer 41 and the second layer 42 between the first layer 41 and the second layer 42. That is, the spacer 43 is interposed between the first layer 41 and the second layer 42. As a result of the spacer 43 being interposed between the first layer 41 and the second layer 42, the first layer 41 and the second layer 42 face each other with a gap S between the first layer 41 and the second layer 42.

As illustrated in FIGS. 7 and 8, the spacer 43 overlaps with the first fixed portion 30 and the second fixed portion 38 of the operation part 20 in plan view. The spacer 43 includes a portion that extends in the Y-axis direction so as to overlap with the second fixed portion 38 in plan view between the first openings 11 that are adjacent to each other in the X-axis direction, and a portion that extends in the X-axis direction so as to overlap with the first fixed portion 30 in plan view between the first openings 11 that are adjacent to each other in the Y-axis direction. That is, the spacer 43 is formed in a lattice shape in plan view.

As illustrated in FIG. 10, the first electrode 44 is disposed on a surface of the first layer 41 facing the Z2 direction. That is, the first electrode 44 is disposed on a surface of the first layer 41 that faces the second layer 42. In addition, the second electrode 45 is disposed on a surface of the second layer 42 facing the Z1 direction. That is, the second electrode 45 is disposed on a surface of the second layer 42 that faces the first layer 41. The first electrode 44 and the second electrode 45 are contacts printed on the substrate using conductive ink paste. Examples of conductive ink paste include carbon and silver.

A first detection unit 46 including the first layer 41, the second layer 42, the first electrode 44, and the second electrode 45, is formed on the membrane switch 4. The first detection unit 46 is a switch mechanism that detects a pressing operation of the operation part 20 while the first electrode 44 and the second electrode 45 come in contact with each other. As illustrated in FIG. 2 or 7, a plurality of first detection units 46 are formed at locations respectively corresponding to each of the plurality of operation parts 20. The first detection unit 46 overlaps with the first movable portion 33 of the operation part 20 in plan view. The first detection unit 46 is located between the first movable portion 33 and the display unit 5. The first detection unit 46 is one example of the “detection unit (detector).”

As illustrated in FIG. 6, in a non-operated state, the first electrode 44 and the second electrode 45 face each other with a gap between the first electrode 44 and the second electrode 45. On the other hand, in the operated state, the protrusion 35 of the first movable portion 33 that has been displaced in the Z2 direction presses the first layer 41 of the first detection unit 46 toward the second layer 42. As a result of the protrusion 35 pressing the first layer 41 toward the second layer 42, the first electrode 44 and the second electrode 45 come into contact with each other. When the first electrode 44 and the second electrode 45 come in contact with each other (in response to the first electrode 44 and the second electrode 45 coming in contact with each other), the voltage of the first detection unit 46 changes. The first detection unit 46 supplies to the control system 200, as an operation signal, a change in the voltage corresponding to the contact/non-contact between the first electrode 44 and the second electrode 45 caused by displacement of first movable portion 33.

In the operated state, the protrusion 35 of the first movable portion 33 presses the first layer 41 of the first detection unit 46 toward the second layer 42, as described above. According to the aspect described above, compared to a configuration in which the first movable portion 33 does not include the protrusion 35, the first movable portion 33 more readily presses the first detection unit 46. Accordingly, the first detection unit 46 can detect the displacement of the first movable portion 33 with high accuracy.

As illustrated in FIG. 9, a plurality of second detection units (second detector) 47 are formed further in the X2 direction than the region in which the plurality of windows 40 are provided in the membrane switch 4. The plurality of second detection units 47 respectively correspond to the plurality of switches 21. The second detection unit 47 includes the first layer 41, the second layer 42, the first electrode 44, and the second electrode 45, in the same manner as the first detection unit 46. The second detection unit 47 overlaps with the corresponding switch 21 in plan view. The second detection unit 47 supplies to the control system 200, as an operation signal, a change in the voltage at the second detection unit 47 corresponding to an operation on the switch 21.

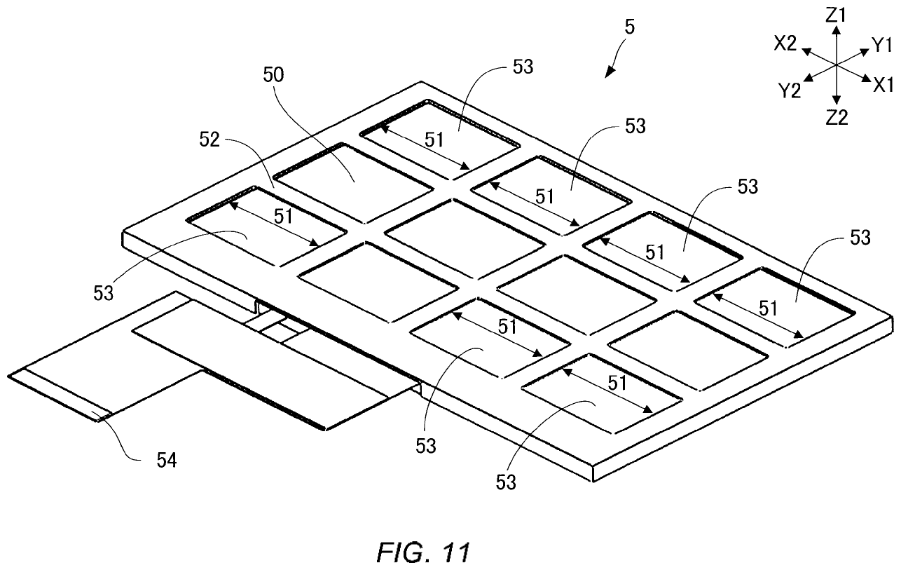

FIG. 11 is a perspective view showing a configuration of the display unit 5. As illustrated in FIG. 11, the display unit 5 is a display such as a flat plate-shaped display device that displays an image under the control of the control system 200. For example, display panels such as a liquid crystal panel or an organic EL panel can be used as the display unit 5.

The display unit 5 has a display surface 50 for displaying images. The display surface 50 includes a plurality of display areas 51 respectively corresponding to the plurality of first openings 11. That is, each of the display areas 51 is an area corresponding to each of the operation parts 20. The display unit 5 is housed in a frame-shaped case 52 corresponding to each of the display areas 51. The areas of the display surface 50 that are located on the inner side of the openings 53 of the case 52 are the display areas 51. The display unit 5 is provided with a terminal 54 for external connection. The terminal 54 is connected to the control system 200 illustrated in FIG. 1. Image data and signals such as synchronization signals are supplied to the display unit 5 from the control system 200 via the terminal 54.

The planar shape of the display unit 5 is a rectangular shape that is elongated in the X-axis direction. As illustrated in FIG. 3, the length L1 of the display unit 5 in the X-axis direction is shorter than the length L2 of the keypad 2 in the X-axis direction. The display unit 5 is installed on the rear side of the area of the keypad 2 in which the plurality of operation parts 20 are provided. That is, the display unit 5 does not overlap with the plurality of switches 21 of the keypad 2 in plan view.

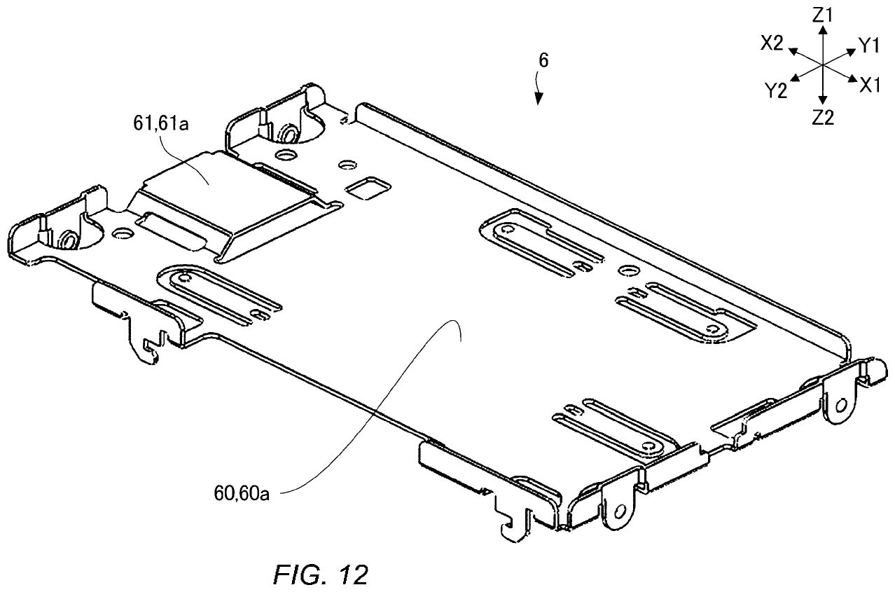

FIG. 12 is a perspective view showing a configuration of the plate-shaped member 6. As illustrated in FIG. 12, the plate-shaped member 6 is a rectangular structure that is elongated in the X-axis direction in plan view A metal material such as electrogalvanized steel sheet (steel electrolytic cold commercial: SECC) can be used as the material of the plate-shaped member 6. However, the material of the plate-shaped member 6 is not limited to the example described above. For example, the material of the plate-shaped member 6 can be a metal material other than electrogalvanized steel sheet or a resin material.

The plate-shaped member 6 includes a base portion 60 and a convex portion 61. The convex portion 61 is located further in the X2 direction than the base portion 60 in the plate-shaped member 6. Specifically, in the plate-shaped member 6, a top surface 61a of the convex portion 61 is located further in the Z1 direction than an upper surface 60a of the base portion 60. The top surface 61a of the convex portion 61 is formed at a position corresponding to the plurality of switches 21 of the keypad 2. The upper surface 60a of the base portion 60 is a flat surface with which the display unit 5 overlaps in plan view.

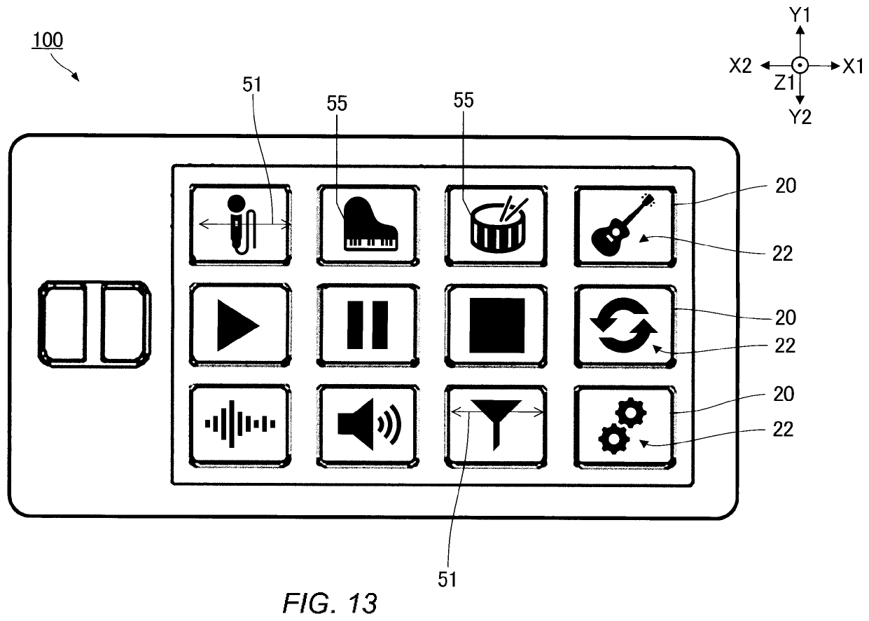

FIG. 13 is a schematic diagram showing a state in which images 55 are displayed on the input device 100 of the first embodiment. As illustrated in FIG. 13, the display unit 5 displays the images 55 in each of the display areas 51 positioned on the rear side of each of the operation parts 20 under the control of the control system 200. A different image 55 is displayed in each of the plurality of display areas 51. For example, in a display area 51 corresponding to each of the operation parts 20, an icon representing a process that is executed by operating the operation part 20 is displayed as the image 55. As described above, the light-transmitting part 22 of the operation part 20 is a member having light-transmitting properties. That is, the light emitted from the display unit 51 is transmitted through the light-transmitting part 22 of the operation part 20 and is emitted to the operation surface 25 side. Accordingly, the user can see the image 55 through the operation part 20.

As described above and as illustrated in FIG. 6, the light-transmitting part 22 rotates with the fixed end 27 serving as a fulcrum. In the operated state, it is easier to press the first movable end 28 in the Z2 direction by pressing a position in the Y2 direction of the base portion 24 than pressing the center of the operation surface 25. Accordingly, compared to a configuration in which the entire operation part 20 is displaced in the direction of the pressing operation, the image 55 of the display unit 5 is less likely to be hidden by the user's body, such as a finger, in the operated state. That is, it is easier to see the image 55 being displayed even during the operated state.

In addition, as described above, the displacement of the first movable portion 33 is detected by the first detection unit 46 located between the first movable portion 33 and the display unit 5. According to the aspect described above, since it is not necessary to detect the displacement of the first fixed portion 30, it is not necessary to install the first detection unit 46 between the first fixed portion 30 and the display unit 5. Accordingly, compared to a configuration in which the entire operation part 20 is displaced in the direction of the pressing operation (a configuration in which the first detection unit 46 overlaps with the entire circumference or with all of the corners of the operation part 20 in plan view), the area of the region of the display unit 5 hidden behind the first detection unit 46 decreases. That is, the display area 51 can be widely secured for the image 55.

As illustrated in FIG. 7, a portion E1, which is a portion (edge portion) of the inner peripheral edge of the window 40 corresponding to the operation part 20 and which is located in the Y1 direction, is located further in the Y1 direction in plan view of a portion E2 which is a portion (edge portion) of the inner peripheral edge of the first opening 11 corresponding to the operation part 20 and which is located in the Y1 direction. According to the aspect described above, compared to a configuration in which the portions E1 and E2 overlap in plan view, the area of the display unit 5 hidden behind the membrane switch 4 is decreased. That is, the display area 51 for the image 55 in the first opening 11 of the support member 1 is enlarged in the Y1 direction. Accordingly, the display area 51 of the image 55 can be widely secured in the Y1 direction.

A lower edge portion E3 of the first fixed portion 30 of the operation part 20 is located in the Y2 direction and located further in the Y1 direction in plan view than the portion E2 that is a portion of the inner peripheral edge of the first opening 11 corresponding to the operation part 20 and is located in the Y1 direction. According to the aspect described above, compared to a configuration in which the lower edge portion E3 and the portion E2 overlap in plan view, the area of the display unit 5 hidden behind the first fixed portion 30 is decreased. That is, the display area 51 for the image 55 in the first opening 11 of the support member 1 is enlarged in the Y1 direction. Accordingly, the display area 51 of the image 55 can be widely secured in the Y1 direction.

As described above, in the input device 100 of the first embodiment, the area of the display unit 5 that is hidden behind the first fixed portion 30 and the membrane switch 4 is decreased, so that the display area 51 for the image 55 can be widely secured. Accordingly, the visibility of the image 55 displayed on the display unit 5 of the input device 100 is improved.

### B: Second Embodiment

The second embodiment of the present disclosure will be described. In each of the embodiments illustrated below, elements that have the same functions as those in the first embodiment have been assigned the same reference symbols used to describe the first embodiment and detailed descriptions thereof have been appropriately omitted.

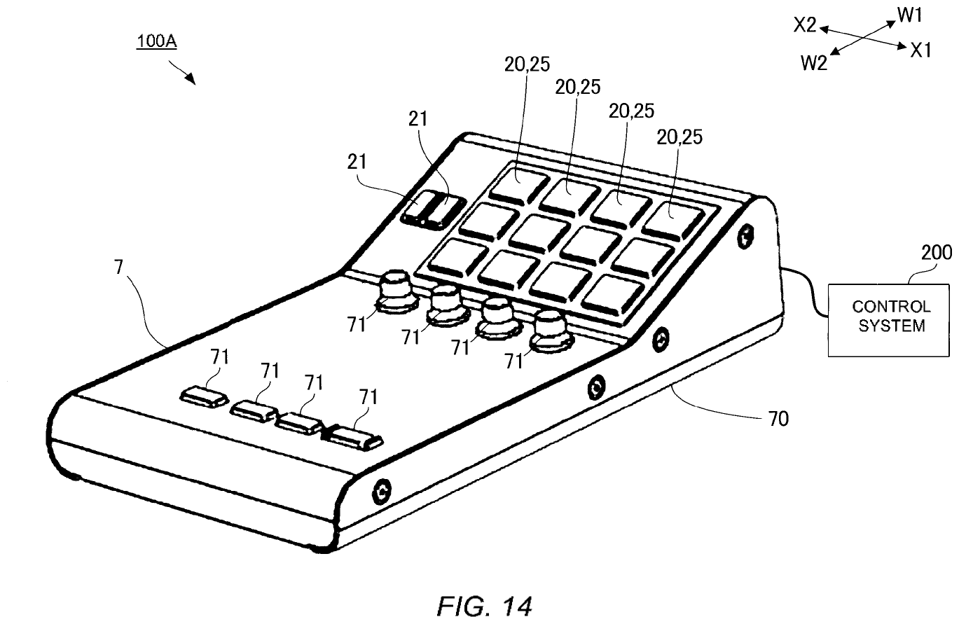

FIG. 14 is a perspective view showing a configuration of an input device 100A according to a second embodiment. As illustrated in FIG. 14, the input device 100A according to the second embodiment includes a housing 7. The housing 7 is a structure that houses the support member 1, the keypad 2, the membrane switch 4, the display unit 5, and the plate-shaped member 6. That is, the input device 100A in the second embodiment includes the input device 100 of the first embodiment, and the housing 7 that houses the input device 100 of the first embodiment. The housing 7 is provided with an opening from which the plurality of operation parts 20 and the plurality of switches 21 are exposed.

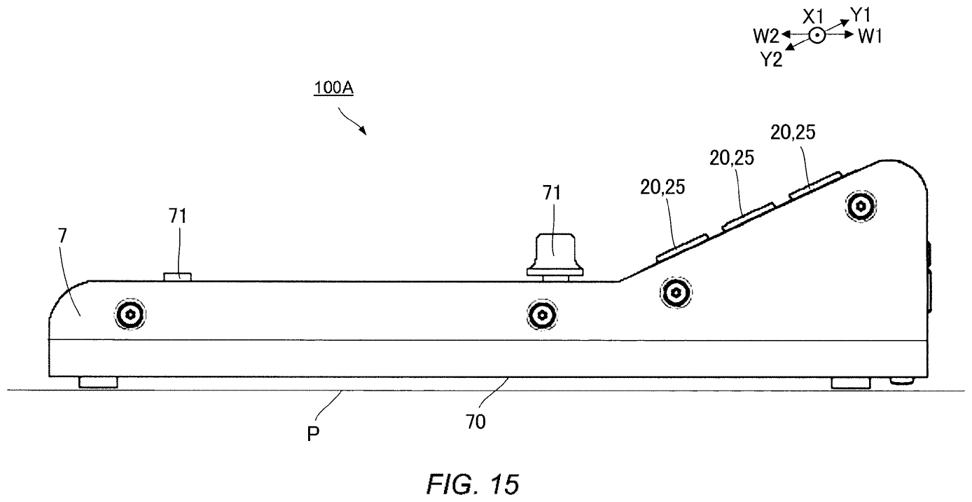

FIG. 15 is a schematic diagram of the input device 100A according to the second embodiment as observed from a line of sight along the X axis. As illustrated in FIG. 15, the input device 100A is placed on a placement surface P. The placement surface P is a horizontal surface, such as the top surface of a desk.

In the following description, a direction orthogonal to the X axis in a plane parallel to the placement surface P is defined as the W axis. That is, the X-W plane is a horizontal plane parallel to the placement surface P. In addition, the lateral direction (horizontal direction) in FIG. 15 is the W axis. One direction along the W axis is defined as the W1 direction, and the direction opposite to the W1 direction is defined as the W2 direction.

The Y axis is inclined about the X axis relative to the placement surface P by a prescribed angle (acute angle). The Y1 direction is directed obliquely upward relative to the placement surface P and the Y2 direction is directed obliquely downward relative to the placement surface P.

The housing 7 has a bottom surface 70 facing the placement surface P of the input device 100A. The bottom surface 70 is a horizontal surface parallel to the placement surface P. The plurality of operation parts 20 are formed in the Y1 direction. The plurality of operation parts 20 are inclined relative to the bottom surface 70. In the aspect described above, the operation surface 25 of each of the operation parts 20 faces obliquely upward relative to the bottom surface 70. That is, the operation surface 25 of each of the operation parts 20 faces the head of the user operating the input device 100A.

As illustrated in FIG. 14 or 15, the housing 7 has a plurality of operators 71. The plurality of operators 71 are mechanisms that detect, as operation signals, the user's operations on the operators 71. The plurality of operators 71 are located further in the W2 direction than the plurality of operation parts 20 of the housing 7. The types of the operators 71 that can be used include push button switches, toggle switches, rotary knobs, and faders. The type, number, arrangement, and shape of the plurality of operators 71 can be changed as appropriate in accordance with the dimensions, etc., of the housing 7.

As illustrated in FIG. 14, the input device 100A is connected to the control system 200 wirelessly or by wire. The control system 200 supplies, to the display unit 5, image data of the image 55 to be displayed by the display unit 5 as well as signals such as synchronization signals. Operation signals detected from the plurality of operation parts 20, the plurality of switches 21, and the plurality of operators 71 of the input device 100A according to the second embodiment are supplied to the control system 200.

As described above, the same effects as those of the first embodiment can be realized by the second embodiment. In addition, in the input device 100A of the second embodiment, the plurality of the operation parts 20 are arranged in the Y1 direction, which is inclined relative to the bottom surface 70 of the housing 7 of the input device 100A. Accordingly, in a state in which the input device 100A is placed on the horizontal placement surface P, the user is able to easily see the image 55 displayed by the display unit 5 via the operation surface 25 of the operation part 20 from the side or obliquely upward of the input device 100A. In addition, since the display area 51 can be widely secured in the Y1 direction, the image 55 as viewed from the side or obliquely upward of the input device 100A is less likely to be cut off.

### C: Modified Example

Specific modified embodiments to be added to each of the embodiments exemplified above are illustrated below. Two or more aspects freely selected from the following examples may be appropriately combined insofar as they are not mutually contradictory.

(1) In each of the embodiments, a configuration is shown in which the light-transmitting part 22 is made of a transparent resin material. However, the material of the light-transmitting part 22 is not limited to resin materials. For example, the light-transmitting part 22 can be made of transparent glass. In a case where the material of the light-transmitting part 22 is glass, the light-transmitting part 22 and the elastic part 23 can be integrally formed by insert molding, or the light-transmitting part 22 and the elastic part 23 that are separately produced can be joined to each other.

(2) In each of the embodiments, a configuration is shown in which the cross-sectional shape of the protrusion 35 of the first movable portion 33 is quadrangular. However, the cross-sectional shape of the protrusion 35 can be freely changed. For example, the cross-sectional shape of the protrusion 35 can be a polygonal shape such as a triangle, or be substantially semicircular.

(3) In each of the embodiments, a configuration is shown in which the first detection unit 46 is the flat plate-shaped membrane switch 4. However, the type of the switch mechanism constituting the first detection unit 46 is not limited to the example described above. For example, the first detection unit 46 can be a mechanical switch. However, as described above, a configuration in which the first detection unit 46 is the flat plate-shaped membrane switch 4 has the advantage that the thickness of the input device 100, 100A can be reduced compared to a configuration in which the first detection unit 46 is a mechanical switch.

(4) In each of the embodiments, a configuration is shown in which the display surface 50 of the display unit 5 includes a plurality of the display areas 51 respectively corresponding to the plurality of first openings 11. However, the configuration of the display unit 5 is not limited to the example described above. For example, it is possible to conceive of a configuration in which a plurality of the display units 5 are installed, respectively corresponding to the plurality of first openings 11.

(5) The term “n-th” (n is a natural number) in the present application is used only as a convenient and a pro forma label for distinguishing elements in the description, and has no substantive meaning. Accordingly, the position of each element, the order of manufacture, etc., are not restricted in any way on the basis of the notation “n-th”.

### D: Addendum

For example, the following configurations can be understood from the embodiments exemplified above.

An input device according to one aspect (first aspect) of this disclosure comprises a plurality of operation parts arranged in a specific direction, a support member provided with a plurality of openings respectively corresponding to the plurality of operation parts, a display unit that is disposed on the rear side of the plurality of operation parts and displays an image, and a detection unit located between the plurality of operation parts and the display unit, wherein each of the plurality of operation parts includes: a light-transmitting part that includes an operation surface that is exposed from an opening corresponding to the operation part from among the plurality of openings, and that transmits light emitted by the display unit; a fixed portion that is disposed at a fixed end of the light-transmitting part located in the specific direction, and that is fixed between the support member and the display unit; and a movable portion that is disposed at a movable end of the light-transmitting part on the side opposite to the fixed end, and that is displaceable by a pressing operation on the operation surface with the fixed portion serving as a fulcrum, and wherein the detection unit is located between the movable portion and the display unit at each of the plurality of operation parts and detects displacement of the movable portion at each of the plurality of operation parts. In the aspect described above, the movable portion of the operating part is displaced with the fixed portion serving as a fulcrum, whereby the displacement of the movable portion caused by a pressing operation on the operation surface is detected. According to the aspect described above, since it is not necessary to detect the displacement of the fixed portion, it is not necessary to install a detection unit between the fixed portion and the display unit. Accordingly, compared to a configuration in which the entire operation part is displaced in the direction of the pressing operation (a configuration in which the detection unit overlaps with the entire circumference or with all of the corners of the operation part in plan view), the area of the region of the display unit hidden behind the detection unit decreases. That is, the display areas can be widely secured for the image. Accordingly, the visibility of the image improves. It should be noted that “rear side” means the side opposite to the user operating each operation part as viewed from the plurality of operation parts. That is, the side opposite to the direction (normal direction) in which the operation surface of each operation part faces.

A specific example (second aspect) of the first aspect further comprises a connecting portion that connects the fixed portion of the first operation part from among the plurality of operation parts and the movable portion of a second operation part that is adjacent to the first operation part from among the plurality of operation parts in the specific direction, wherein the connecting portion is elastically deformed with the fixed portion of the first operation part serving as a fulcrum by a pressing operation on the operation surface of the second operation part. In the aspect described above, since the fixed portion of the first operation part and the movable portion of the second operation part are connected by the connecting portion, compared to a form in which the fixed portion of the first operation part and the movable portion of the second operation part are configured as separate bodies, it is easier to fix the relative positions of the fixed portion of the first operation part and the movable portion of the second operation part. Accordingly, it is easy to install the fixed portion of the first operation part and the movable portion of the second operation part while maintaining the target positional relationship between the fixed portion of the first operation part and the movable portion of the second operation part. In addition, since the connecting portion between the fixed portion of the first operation part and the movable portion of the second operation part is elastically deformed, compared to a form in which the movable portion of the second operation part is directly connected to the fixed portion of the first operation part, it is easier to ensure a range in which the movable portion of the second operation part can be displaced with respect to the fixed portion of the first operation part.

In a specific example (third aspect) of the second aspect, the detection unit is a planar membrane switch in which a plurality of windows are formed, the windows being opened respectively corresponding to the plurality of operation parts; the membrane switch comprises a flexible first layer, a flexible second layer that faces the first layer with a gap between the second layer and the first layer, a first electrode disposed on a surface of the first layer facing the second layer, and a second electrode disposed on a surface of the second layer facing the first layer; the first electrode and the second electrode overlap the movable portion in plan view; the first electrode and the second electrode come in contact with each other by the first layer being pressed toward the second layer due to displacement of the movable portion; and a portion of the inner peripheral edge of, from among the plurality of windows, a window corresponding to the first operation part located in the specific direction is located further in the specific direction in plan view of a portion of the inner peripheral edge of the opening corresponding to the first operation part located in the specific direction. In the aspect described above, compared to a configuration in which a portion of the inner peripheral edge of a window corresponding to the first operation part located in the specific direction and a portion of the inner peripheral edge of the opening corresponding to the first operation part located in the specific direction overlap with each other, the area of the display unit hidden behind the membrane switch is decreased. That is, the display area for the image in the opening of the support member is enlarged in the specific direction. Accordingly, the display area of the image can be widely secured in the specific direction.

In a specific example (fourth aspect) of the third aspect, the membrane switch further comprises a spacer that comes in contact with the first layer and the second layer between the first layer and the second layer, the first layer and the second layer are contiguous across the fixed portion of the first operation part and the movable portion of the second operation part in plan view, and the spacer overlaps the fixed portion of the first operation part in plan view. According to the aspect described above, it is possible to secure a gap corresponding to the thickness of the spacer between the first layer and the second layer (and further between the first electrode and the second electrode). In addition, in a configuration in which the spacer does not overlap the fixed portion of the first operation part in plan view, there needs to be an area of the display unit that is hidden behind the fixed portion of the first operation part separate from an area of the display unit that is hidden behind the spacer. According to the fourth aspect, since the spacer overlaps the fixed portion of the first operation part in plan view, it is possible to reduce the area of the region of the display unit that overlaps the fixed portion and the spacer in plan view. That is, it is easy to secure a display area for an image on the display unit.

In a specific example (fifth aspect) of any one of the first-fourth aspects, a lower edge portion of the fixed portion of the operation part is located further in the specific direction in plan view than a portion of the inner peripheral edge of the opening corresponding to the operation part located in the specific direction. According to the aspect described above, compared to a configuration in which the lower edge portion of the fixed portion of the operating part overlaps with a portion of the inner peripheral edge of an opening corresponding to said operation part located in the specific direction in plan view, the area of the display unit hidden behind the fixed portion is decreased. That is, the display area for the image in the opening of the support member is enlarged in the specific direction. Accordingly, the display area of the image can be widely secured in the specific direction.

In a specific example (sixth aspect) of any one of the first-fifth aspects, the support member includes a protrusion that protrudes from the rear surface of the support member toward the display unit, the protrusion comes in contact with the fixed portion, and the fixed portion is located between the protrusion and the display unit. According to the aspect described above, the fixing portion is pressed toward the display unit by the protrusion of the support member. Accordingly, compared to a configuration in which the support member does not include the protrusion, the fixed portion can be more firmly fixed.

In a specific example (seventh aspect) of any one of the first-sixth aspects, the light-transmitting part includes a base portion including the operation surface; and the fixed end protrudes from a side surface of the base portion in the specific direction, is positioned between the support member and the fixed portion, and comes in contact with the support member. According to the aspect described above, a fixed end that protrudes from the side surface of the base portion is located between the support member and the fixing portion. Accordingly, the fixed end of the light-transmitting portion can be more firmly fixed by the support member and the fixed portion.

In a specific example (eighth aspect) of any one of the first-seventh aspects, the movable portion comes in contact with the rear surface of the support member in a non-operated state in which the pressing operation is not applied to the operation surface. In the aspect described above, as a result of the movable portion coming in contact with the rear surface of the support member in the non-operated state, it is possible to stabilize the position of the movable portion in the non-operated state.

In a specific example (ninth aspect) of any one of the first-eighth aspects, the device comprises a housing that houses the plurality of operation parts, the support member, the display unit, and the detection unit; the housing includes a bottom surface that faces a placement surface for the input device; and the specific direction is a direction inclined relative to the bottom surface. In the aspect described above, a plurality of the operation parts are arranged in the specific direction, which is inclined relative to the bottom surface of the housing of the input device. Accordingly, for example, in a state in which the input device is placed on a horizontal placement surface, the user is able to easily see the display image displayed by the display unit via the operation surface of the operation part from the side or obliquely upward of the input device.

What is claimed is:

1. An input device comprising:
a plurality of operation parts arranged in a specific direction;
a support member including a plurality of openings that correspond to the plurality of operation parts, respectively;
a display disposed on a rear side of the plurality of operation parts, the display being configured to display an image; and
a detector located between the plurality of operation parts and the display,
each of the plurality of operation parts including
a light-transmitting part that includes an operation surface exposed from each of the plurality of openings corresponding to each of the plurality of operation parts, the light-transmitting part being configured to transmit light emitted by the display,
a fixed portion disposed on a fixed end of the light-transmitting part, the fixed end being located in the specific direction, the fixed portion being fixed between the support member and the display, and
a movable portion disposed at a movable end of the light-transmitting part, the movable end being opposite to the fixed end, the movable portion being displaceable by a pressing operation on the operation surface with the fixed portion serving as a fulcrum, and
the detector being located between the display and the movable portion of each of the plurality of operation parts, the detector being configured to detect displacement of the movable portion of each of the plurality of operation parts.

2. The input device according to claim 1, wherein
the plurality of operation parts include a connecting portion that connects the fixed portion of a first operation part of the plurality of operation parts and the movable portion of a second operation part of the plurality of operation parts, the second operation part is adjacent to the first operation part in the specific direction, and
the connecting portion is elastically deformed with the fixed portion of the first operation part serving as a fulcrum, by a pressing operation on the operation surface of the second operation part.

3. The input device according to claim 2, wherein
the detector is a flat plate-shaped membrane switch in which a plurality of windows are formed, the windows are open corresponding to the plurality of operation parts, respectively,
the flat plate-shaped membrane switch includes
a first flexible layer,
a second flexible layer that faces the first flexible layer with a gap between the first flexible layer and the second flexible layer,
a first electrode disposed on a surface of the first flexible layer facing the second flexible layer, and
a second electrode disposed on a surface of the second flexible layer facing the first flexible layer,
the first electrode and the second electrode overlap the movable portion in plan view,
the first electrode and the second electrode are configured to contact with each other by the first flexible layer being pressed toward the second flexible layer due to displacement of the movable portion, and
an inner peripheral edge of, from among the plurality of windows, a window corresponding to the first operation part has an edge portion located in the specific direction, an inner peripheral edge of the opening that corresponds to the first operation part has an edge portion located in the specific direction, and the edge portion of the window is located further in the specific direction in the plan view than the edge portion of the opening that corresponds to the first operation part.

4. The input device according to claim 3, wherein
the membrane switch further includes a spacer that is disposed between the first flexible layer and the second flexible layer and contacts the first flexible layer and the second flexible layer,
the first flexible layer and the second flexible layer are contiguous across the fixed portion of the first operation part and the movable portion of the second operation part in the plan view, and
the spacer overlaps the fixed portion of the first operation part in the plan view.

5. The input device according to claim 1, wherein
a lower edge portion of the fixed portion of each of the plurality of operation parts is located further in the specific direction in plan view than an edge portion of an inner peripheral edge of each of the plurality of openings corresponding to each of the plurality of the operation parts, and the edge portion of the inner peripheral edge of the plurality of openings is located in the specific direction.

6. The input device according to claim 1, further comprising
a protrusion that protrudes from a rear surface of the support member toward the display, wherein
the protrusion contacts with the fixed portion, and
the fixed portion is located between the protrusion and the display.

7. The input device according to claim 1, wherein
the light-transmitting part includes a base portion with the operation surface, and
the fixed end protrudes from a side surface of the base portion in the specific direction, is positioned between the support member and the fixed portion, and contacts with the support member.

8. The input device according to claim 1, wherein
the movable portion is configured to contact with a rear surface of the support member in a non-operated state in which the pressing operation is not applied to the operation surface.

9. The input device according to claim 1, further comparing
a housing that houses the plurality of operation parts, the support member, the display, and the detector, wherein
the housing includes a bottom surface that faces a placement surface for the input device, and
the specific direction is a direction inclined relative to the bottom surface.
